(19) United States
(12) Patent Application Publication
(10) Pub. No.: US 2024/0083443 A1
(43) Pub. Date: Mar. 14, 2024

(54) DRIVING STATE MONITORING DEVICE, DRIVING STATE MONITORING METHOD, AND DRIVING STATE MONITORING SYSTEM

(71) Applicant: NEC Corporation, Tokyo (JP)

(72) Inventors: Kazuki INAGAKI, Tokyo (JP); Hidenori Tsukahara, Tokyo (JP); Nana Sakuma, Tokyo (JP); Kazuki Ogata, Tokyo (JP)

(73) Assignee: NEC Corporation, Tokyo (JP)

(21) Appl. No.: 18/515,537

(22) Filed: Nov. 21, 2023

Related U.S. Application Data
(63) Continuation of application No. 16/963,375, filed on Jul. 20, 2020.

(30) Foreign Application Priority Data
Jan. 25, 2018 (JP) 2018-010903

(51) Int. Cl. B60W 40/09; G06V 20/59; G06V 40/16

(52) U.S. Cl. CPC B60W 40/09; G06V 20/597; G06V 40/168; B60W 2540/043

(57) ABSTRACT

A driving-state monitoring system includes a driving-state monitoring device and a driving-state sensing device. The driving-state sensing device captures an image of a driver of a vehicle to thereby generate driving-state data. The driving-state monitoring device acquires the driving-state data and the captured image of a driver of a vehicle from the driving-state sensing device. An authentication process is made to determine whether or not a driver matches a pre-registered driver based on the information of a driver included in the captured image, thus determining the identification information of the driver successfully authenticated. The driving-state data is recorded on a database in association with the identification information of the driver. Accordingly, it is possible for the driving-state monitoring device to monitor a plurality of vehicles using a plurality of driving-state sensing devices, thus precisely managing a plurality of vehicles in terms of their driving states.

### CROSS REFERENCE TO RELATED APPLICATIONS

This application is a continuation application of U.S. patent application Ser. No. 16/963,375 filed on Jul. 20, 2020, which is a National Stage of International Application No. PCT/JP2019/001249, filed Jan. 17, 2019, claiming priority to Japanese Patent Application No. 2018-010903, filed Jan. 25, 2018, the contents of all of which are incorporated herein by reference in their entirety.

### TECHNICAL FIELD

The present invention relates to a driving-state monitoring device, a driving-state monitoring method, and a driving-state monitoring system.

### BACKGROUND ART

Technologies for acquiring various types of data during driving vehicles and for monitoring driving states have been developed for vehicles such as automobiles. For example, Patent Document 1 discloses a technology of capturing facial pictures of drivers, recognizing drivers based on facial pictures, and thereby calculating fuel information for each driver. Patent Document 2 discloses a technology of receiving information regarding the occurrence of risk events such as close-call incidents and accidents of vehicles used to collect information, creating databases at information-distribution centers to store conditions of causing risk events associated with risk positions, and distributing assistance information to vehicles for safety driving based on databases.

### CITATION LIST

### Patent Literature Document

Patent Document 1: Japanese Patent Application Publication No. 2015-79359
Patent Document 2: Japanese Patent Application Publication No. 2013-117809

### SUMMARY OF INVENTION

### Technical Problem

The aforementioned technologies are insufficient to individually identify a driver of a vehicle and to assist safety driving. For example, it is necessary to provide a technology of managing information upon precisely acquiring a driving state of a driver who may be allowed to drive a plurality of vehicles.

To solve the aforementioned problem, the present invention aims to provide a driving-state monitoring device, a driving-state monitoring method, and a driving-state monitoring system, which can monitor a driving state for each driver upon authenticating each driver.

### Solution to Problem

In a first aspect of the present invention, a driving-state monitoring device includes an acquisition part configured to acquire a captured image of a driver of a vehicle and driving-state data, an identification part configured to carry out an authentication process as to whether the driver matches a driver registered in advance based on the information of the driver included in the captured image and to thereby determine the identification information of the driver successfully authenticated, and a recording part configured to record the driving-state data in connection with the identification information of the driver determined based on the captured image corresponding to the driving-state data.

In a second aspect of the present invention, a driving-state monitoring system includes a driving-state monitoring device and a driving-state sensing device. The driving-state monitoring device further includes an acquisition part configured to acquire a captured image of a driver of a vehicle and driving-state data which are transmitted from the driving-state sensing device, an identification part configured to carry out an authentication process as to whether the driver matches a driver registered in advance based on the information of the driver included in the captured image and to thereby determine the identification information of the driver successfully authenticated, and a recording part configured to record the driving-state data in connection with the identification information of the driver determined based on the captured image corresponding to the driving-state data.

In a third aspect of the present invention, a driving-state monitoring method is adapted to a driving-state monitoring device configured to communicate with a driving-state sensing device. The driving-state monitoring method includes the steps of: acquiring driving-state data and a captured image of a driver of a vehicle which are transmitted from the driving-state sensing device, carrying out an authentication process as to whether the driver matches a driver registered in advance based on the information of the driver included in the captured image so as to determine the identification information of the driver successfully authenticated, and recording the driving-state data in association with the identification information of the driver determined based on the captured image corresponding to the driving-state data.

In a fourth aspect of the present invention, it is possible to provide a program causing a computer to implement the driving-state monitoring method or a storage medium configured to store the program.

### Advantageous Effects of Invention

According to the present invention, it is possible to monitor a driving state of a driver who may be allowed to drive a plurality of vehicles and to thereby precisely manage driving-state data and images of each driver obtained from a driving-state sensing device (or a drive recorder) for each driver.

### BRIEF DESCRIPTION OF DRAWINGS

FIG. 1 is a schematic diagram of a driving-state monitoring system according to the embodiment of the present invention.

FIG. 2 is a hardware configuration diagram of a driving-state monitoring device according to the embodiment of the present invention.

FIG. 3 is a functional block diagram of the driving-state monitoring device according to the embodiment of the present invention.

FIG. 4 is a hardware configuration diagram of a drive recorder configured to communicate with the driving-state monitoring device.

FIG. 5 is a functional block diagram of a control device of the drive recorder.

FIG. 6 is a flowchart showing a first procedure of the drive recorder.

FIG. 7 is a flowchart showing a second procedure of the drive recorder.

FIG. 8 is a flowchart showing a procedure of the driving-state monitoring device.

FIG. 9 is a block diagram showing a minimum configuration of the driving-state monitoring device.

### DESCRIPTION OF EMBODIMENTS

The present invention will be described in detail by way of embodiments with reference to the accompanying drawings.

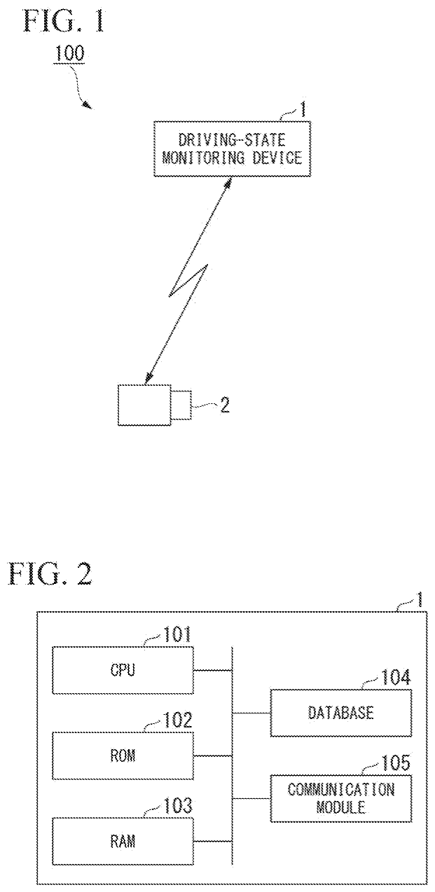

As show in FIG. 1, a driving-state monitoring system 100 includes a driving-state monitoring device 1 and a drive recorder 2 serving as one example of a driving-state sensing device. The driving-state monitoring device 1 is connected to the drive recorder 2 through a wireless communication network or a wired communication network. For example, the drive recorder 2 is mounted on a vehicle. The driving-state monitoring device 1 may communicate with drive recorders 2 mounted on vehicles traveling through cities or towns.

FIG. 2 is a hardware configuration diagram of the driving-state monitoring device 1. As shown in FIG. 2, the driving-state monitoring device 1 is a computer including hardware elements such as a CPU (Central Processing Unit) 101, a ROM (Read-Only Memory) 102, a RAM (Random-Access Memory) 103, a database 104, and a communication module 105.

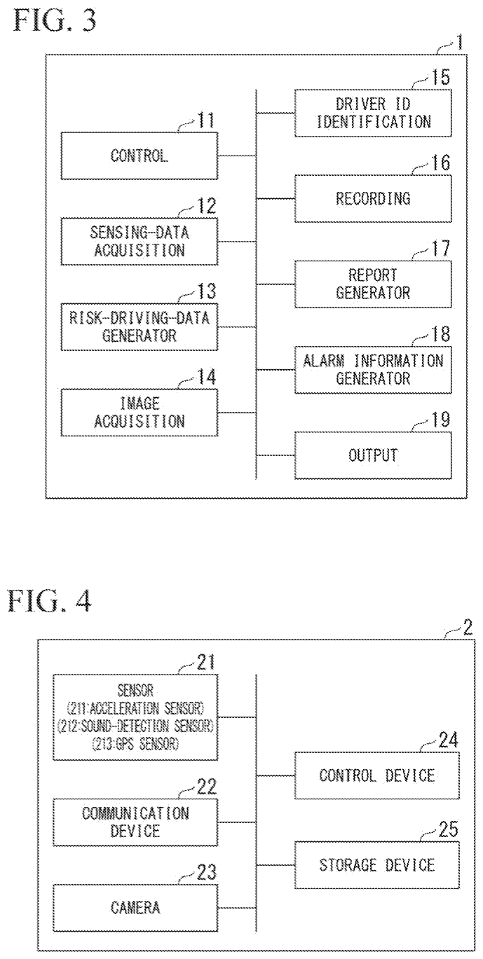

FIG. 3 is a functional block diagram of the driving-state monitoring device 1. Upon applied power, the driving-state monitoring device 1 starts its operation to execute driving-state monitoring programs which are stored on the ROM 102 in advance. Accordingly, it is possible to realize the functional parts of the driving-state monitoring device 1 such as a control part 11, a sensing-data acquisition part 12, a risk-driving-data generator 13, an image acquisition part 14, a driver ID identification part 15, a recording part 16, a report generator 17, an alarm information generator 18, and an output part 19.

The control part 11 is configured to control the functional parts 12 through 19 of the driving-state monitoring device 1. The sensing-data acquisition part 12 is configured to acquire driving-state data including driving states having multiple items and event data notifying the occurrence of various events during driving from a plurality of drive recorders 2 configured to communicate with the driving-state monitoring device 1. The risk-driving-data generator 13 is configured to generate risk driving data including a driving state having any one item which is selected from among multiple items according to attributes of a driver as well as event data.

The image acquisition part 14 is configured to acquire image data capturing images of drivers for authentication which are received from a plurality of drive recorders 2 configured to communicate with the driving-state monitoring device 1. The image acquisition part 14 is configured to acquire an upload image, which is identified according to attributes of a driver and selected from among image data captured by drive recorders 2, from the drive recorder 2 at an acquisition timing to generate risk driving data.

The driver ID identification part 15 is configured to carry out an authentication process as to whether a driver of a vehicle matches a pre-registered driver based on an image of a driver included in the image data for authentication. Upon successfully authenticating a driver, the driver ID identification part 15 should identify a driver ID. The recording part 16 is configured to record the image data for authentication and the driving-state data transmitted from the drive recorder 2 in connection with the driver ID identified by the drive ID identification part 15. The report generator 17 is configured to generate the report data according to attributes of a driver using at least risk driving data. Triggered by generation of risk driving data, the alarm information generator 18 is configured to generate the alarm information according to attributes of a driver. The output part 19 is configured to output the report data and the alarm data. For example, the output part 19 may output those data to an external device or display them on the screen of a display.

FIG. 4 is a hardware configuration diagram of the drive recorder 2. The drive recorder 2 includes a sensor 21, a communication device 22, a camera 23, a control device 24, and a storage device 25. As the sensor 21, for example, it is possible to use an acceleration sensor 211, a sound-detection sensor 212, and a GPS sensor 213. The sensor 21 may be mounted on a vehicle outside the drive recorder 2. In this case, the drive recorder 2 may obtain the information detected by the sensor 21.

The communication device 22 is configured to communicate with the driving-state monitoring device 1. The camera 23 is configured to capture images inside and/or outside the vehicle and to thereby generate moving images and/or still images. The control device 24 is configured to control functional parts of the drive recorder 2. The storage device 25 is configured to store moving images and/or still images as well as various pieces of information detected by the sensor 21. The drive recorder 2 may communicate with the driving-state monitoring device 1 through base stations and the like. In this connection, the control device 24 of the drive recorder 2 may be a computer including a CPU, a ROM, a RAM, and the like.

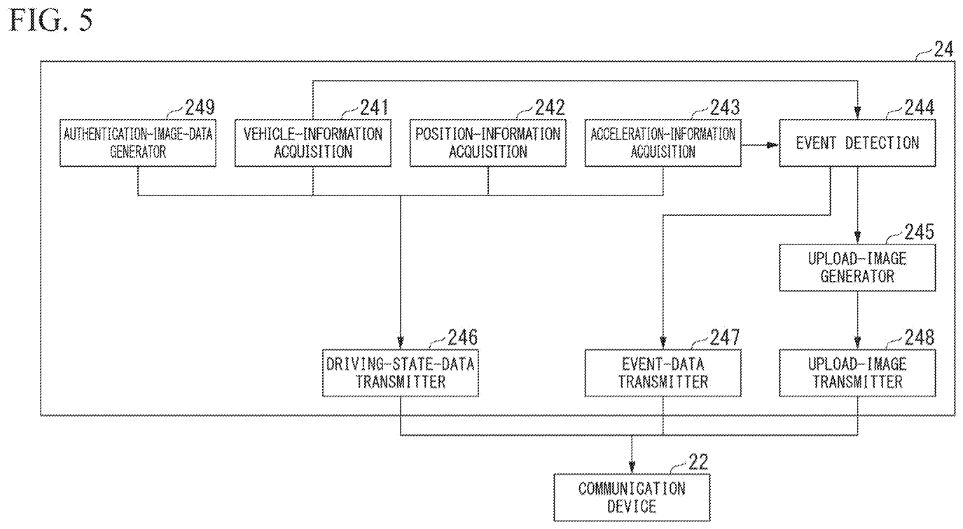

FIG. 5 is a functional block diagram of the control device 24 of the drive recorder 5. When the drive recorder 2 starts its operation, the control device 24 may execute control programs which are stored in advance. Accordingly, it is possible for the control device 24 to realize various functional parts such as a vehicle-information acquisition part 241, a position-information acquisition part 242, an acceleration-information acquisition part 243, an event detection part 244, an upload image generator 245, a driving-state-data transmitter 246, an event data transmitter 247, an upload image transmitter 248, and an authentication-image-data generator 249.

The vehicle-information acquisition part 241 is configured to acquire the vehicle information including the information (e.g. a vehicle type, a vehicle ID) stored in a memory card inserted into the drive recorder 2 and other information such as an acceleration of a vehicle and the sensing information (i.e. the information other than the vehicle position information) detected by a sensor mounted on a vehicle. For example, the vehicle information acquired by the vehicle-information acquisition part 241 may include a drive-start time, a drive-stop time, speed of a vehicle at each timing, and temperature of a vehicle.

The position-information acquisition part 242 is configured to acquire the position information of a vehicle (i.e. a latitude and a longitude) at each timing from the GPS sensor 213. The acceleration-information acquisition part 243 is configured to acquire the acceleration information of a vehicle at each timing from the acceleration sensor 211. The event detection part 244 is configured to determine the occurrence of a desired event on a vehicle based on the acceleration of a vehicle. As a desired event, it is possible to mention a risk event. For example, the desired event may be an event of rapidly accelerating or rapidly decelerating a vehicle. Specifically, the event detection part 244 may detect the occurrence of various events based on conditions (or operating condition data) which are determined according to attributes of a driver.

The upload image generator 245 is configured to acquire moving images and/or still images captured by the camera 23, to generate upload images including moving images and/or still images at event-occurring timing, and to thereby transmit upload images through the communication device 22. Specifically, the upload image generator 245 may generate moving images and/or still images at event-occurring timing based on conditions determined according to attributes of a driver.

The driving-state-data transmission part 246 is configured to transmit the driving-state data, which includes the vehicle information, the position information, the acceleration information, and the authentication image data, to the driving-state monitoring device 1. The event data transmitter 247 is configured to transmit the event data when the event detection part 244 detects the occurrence of an event. The event data may be furnished with an identifier representing the type of an event. The upload image transmitter 248 is configured to transmit the upload image data, which is produced by the upload image generator 245 and which may represent a moving image and/or a still image at an event-occurring timing, to the driving-state monitoring device 1.

The authentication image data generator 249 is configured to generate the authentication image data upon acquiring a moving image (or a captured image) captured by the camera 23 of the drive recorder 2. In this connection, the authentication image data may represent one example of a captured image. In the present embodiment, the authentication image data is image data including a facial picture of a driver. To improve an authentication accuracy, the authentication image data generator 249 may generate the authentication image data using an image process to enlarge a facial image of the captured image. In this connection, the authentication image data may include a plurality of frame images which are extracted from plenty of frame images included in captured images over a lapse of time. For example, the authentication image data may include ten frame images among captured images. The authentication-image-data generator 249 is configured to generate the authentication image data in predetermined intervals of time based on captured images which are being continuously captured by the drive recorder 2 during its operation.

For example, the aforementioned operation condition data may include a risk level, which associates a risk identifier, an acceleration condition, a speed condition, and an operation flag with each other, and a risk drive type which associates a risk-type identifier, an acceleration direction, speed, and an operation flag with each other. A decision whether or not to establish an operation flag has been set in advance according to attributes of a driver. As described above, the operation condition data may stipulate the risk level and the risk drive type based on the acceleration and the speed. The operation flag is set according to attributes of a driver. For example, a driver has its attribute representing a company which the driver belongs to; hence, some personnel of the company may set an operation flag, which is held in the operation condition data.

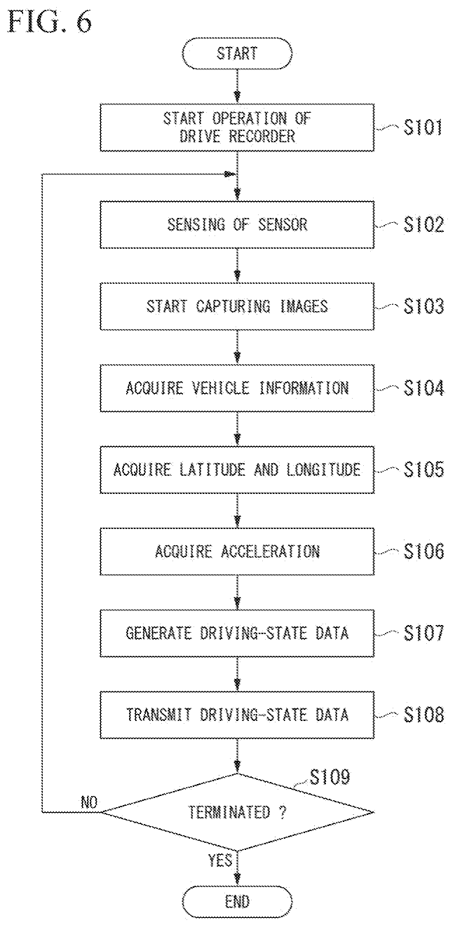

FIG. 6 is a flowchart showing a first procedure of the drive recorder 2. The processing of the driving-state monitoring system 100 will be described with reference to the flowchart of FIG. 6 (steps S101 through S109). First, a transmission process of the driving-state information by the drive recorder 2 will be described below.

Upon starting an electrical system of a vehicle, the drive recorder 2 starts its operation (S101). The sensor 21 of the drive recorder 2 starts to carry out various types of sensing operation after startup of the drive recorder 2 (S102). In addition, the camera 23 starts to capture images (S103). During the operation of the drive recorder 2 in progress, the vehicle-information acquisition part 241 of the control device 24 may acquire the vehicle information (S104). The vehicle-information acquisition part 241 may repeatedly acquire sensing information included in vehicle information at predetermined intervals of time. The position-information acquisition part 242 may acquire the position of a vehicle such as a latitude and a longitude from the GPS sensor 213 in predetermined intervals of time (S105). The acceleration-information acquisition part 243 may acquire the acceleration of a vehicle from the acceleration sensor 211 in predetermined intervals of time (S106). The authentication-image-data generator 249 may generate the authentication image data based on captured images obtained from the camera 23 in predetermined intervals of time. For example, the predetermined interval of time may be set to 0.1 seconds. In this connection, the authentication-image-data generator 249 may generate the authentication image data for each minute longer than an interval of time to acquire other sensing information. The driving-state data transmitter 246 may acquire the vehicle information, the position information (i.e. a latitude and a longitude), the acceleration of a vehicle, and the authentication image data so as to generate the driving-state data including those pieces of information, the time of generating the driving-state data, and an ID of the drive recorder 2 (S107). The driving-state data transmitter 246 instructs the communication device 22 to transmit the driving-state data to the driving-state monitoring device 1 (S108). The control device 24 determines whether to terminate the transmission process (S109). The drive recorder 2 may repeatedly execute a series of steps S102 through S108 until a decision to terminate the transmission process (i.e. a decision result “YES” of step S109).

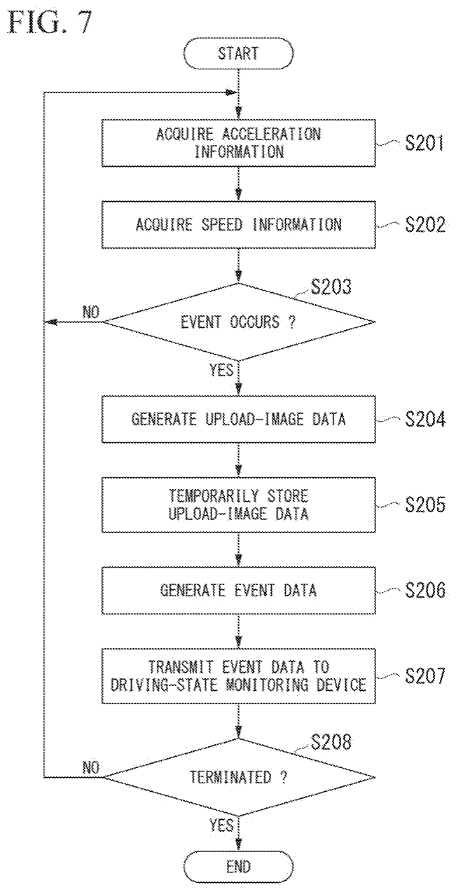

FIG. 7 is a flowchart showing a second procedure of the drive recorder 2 (steps S201 through S208). The drive recorder 2 may carry out an event detection process in parallel with a transmission process of the driving-state information. First, upon starting the drive recorder 2, the event detection part 244 of the control device 24 may acquire the acceleration information of a vehicle from the acceleration-information acquisition part 243 in predetermined intervals of time (S201). The event detection part 244 may acquire the speed information of a vehicle from the vehicle-information acquisition part 241 in predetermined intervals of time (S202). The event detection part 244 detects the occurrence of an event on a vehicle according to time-related changes of the acceleration and the speed of a vehicle (S203). The present embodiment uses a risk event as an event of a vehicle. In this connection, it is possible to determine whether or not any event occurs in a vehicle according to attributes of a driver.

Specifically, the event detection part 244 is configured to acquire the aforementioned operation condition data. The operation condition data includes a risk level which may hold an operation flag for each acceleration according to a risk. The operation condition data includes a risk-drive type which may hold an operation flag for each speed and its acceleration direction according to the type of risk driving. The event detection part 244 may detect the occurrence of an event of a vehicle upon establishing at least one of a first condition indicating the running condition of a vehicle reaching an acceleration having a risk corresponding to an operation flag “1” and a second condition indicating the running condition of a vehicle reaching the speed and the acceleration condition having a risk-drive type corresponding to an operation flag “1”. In this connection, an operation flag to be held by a risk level or a risk-drive type can be set according to attributes of a driver. For this reason, it is possible to detect the occurrence of an event of a vehicle according to attributes of a driver.

Upon detecting the occurrence of an event of a vehicle, the event detection part 244 may instruct the upload image generator 245 to generate the upload image data. The upload image generator 245 has acquired images captured by the camera 23 of the drive recorder 2. Upon inputting a detection signal representing the occurrence of an event of a vehicle from the event detection part 244, the upload image generator 245 may generate the upload image data based on captured images obtained from the camera 23 (S204). Specifically, the upload image generator 245 is configured to generate still images and/or moving images in a predetermined time. In this connection, it is possible to determine the number of still images, an image-capture timing relative to an event-occurring time of still images, a reproduction time of moving images, and a moving-image start timing relative to an event-occurring time of moving images according to attributes of a driver. The upload image generator 245 may temporarily store still images, moving images, an image-generation timing, and an ID of the drive recorder 2 (S205). The upload image generator 245 may delete the upload image data in a lapse of a predetermined period such as one week or so after a timing of generating the upload image data.

Upon detecting the occurrence of an event of a vehicle, the event detection part 244 is configured to generate event data (S206). The event data may include speed and acceleration at a timing of detecting an event of a vehicle, an event-occurring time, and an ID of the drive recorder 2. In addition, the event data may further include the position information of a vehicle (i.e. a latitude and a longitude) and other sensing information. The event data transmitter 247 is configured to acquire the event data from the event detection part 244. The event data transmitter 247 may instruct the communication device 22 to transmit the event data to the driving-state monitoring device 1. The communication device 22 may transmit the event data to the driving-state monitoring device 1 (S207). The control device 24 is configured to determine whether or not to terminate the event detection process (S208). The drive recorder 2 may repeatedly execute a series of steps S202 through S207 until a decision of terminating the event detection process (i.e. a decision result “YES” of step S208).

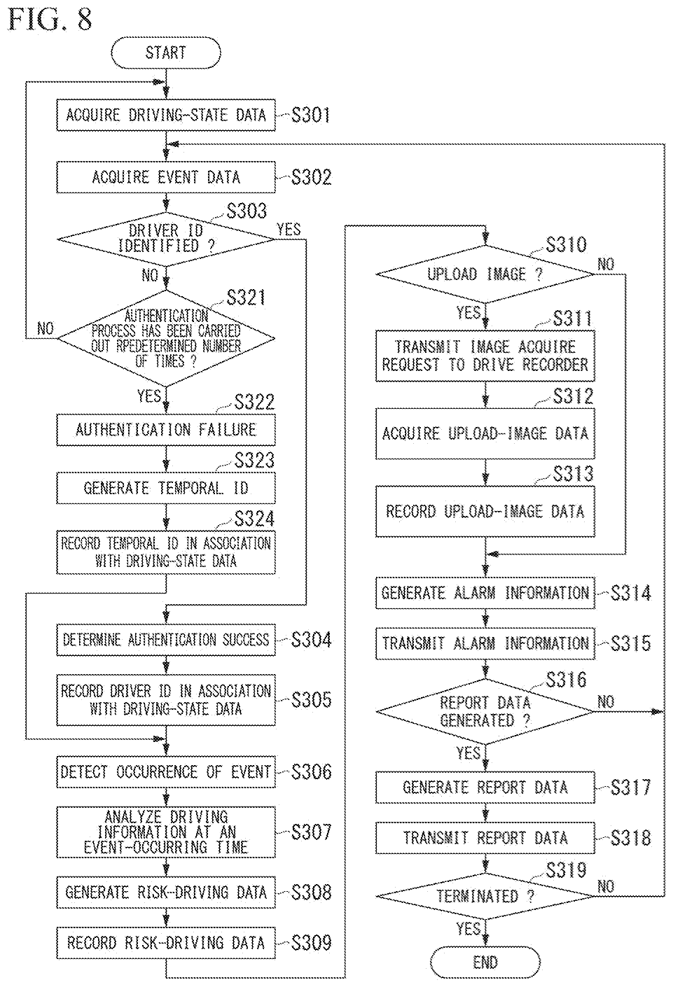

FIG. 8 is a flowchart showing the processing of the driving-state monitoring device 1 (steps S301 through S319, S321 through S324). In the driving-state monitoring device 1, the sensing-data acquisition part 12 is configured to acquire the driving-state data, which is transmitted from the communication device 22 of the drive recorder 2 mounted on a vehicle, via the communication module 105 (S301). In addition, the sensing-data acquisition part 12 is configured to acquire the event data, which is transmitted from the communication device 22 of the drive recorder 2, via the communication module 105 (S302). The driver ID identification part 15 is configured to acquire the authentication image data included in the driving-state data. The driver ID identification part 15 is configured to generate facial feature information from images included in the authentication image data. The driver ID identification part 15 may sequentially acquire combinations of the driver ID and the facial feature information with respect to a plurality of drivers registered in the database 104 in advance. The driver ID identification part 15 is configured to calculate a degree of coincidence between the facial feature information obtained from the database 104 and the facial feature information which is generated based on the authentication image data. As a method of calculating a degree of coincidence, it is possible to use a known calculation method. The driver ID identification part 15 is configured to carry out an authentication process. That is, the driver ID identification part 15 may identify one or multiple driver IDs, which are associated with the facial feature information used to calculate a degree of coincidence equal to or more than a predetermined threshold, among driver IDs obtained from the database 104. In addition, the driver ID identification part 15 may determine whether to successfully identify the driver ID according to a degree of coincidence (S303). Specifically, upon identifying a single driver ID, the driver ID identification part 15 determines a successful authentication of the driver ID having a degree of coincidence equal to or more than the predetermined threshold (S304). Upon identifying a plurality of driver IDs, the driver ID identification part 15 determines a successful authentication for a single driver ID among driver IDs. Specifically, the driver ID identification part 15 may calculate an average value among degrees of coincidence for driver IDs. The driver ID identification part 15 may identify a driver ID having a highest average value among degrees of coincidence as a driver ID of a driver who drives a vehicle. The driver ID identification part 15 identifies a driver ID corresponding to the driving-state data obtained from the drive recorder 2 and outputs the driver ID to the recording part 16. The recording part 16 is configured to record the driver ID, the driving-state data, and the ID of the drive recorder 2 included in the driving-state data, which are associated with each other (S305).

The risk-driving-data generator 13 is configured to detect the occurrence of an event of a vehicle equipped with the drive recorder 2 based on the event data (S306). Upon detecting the occurrence of an event, the risk-driving-data generator 13 may analyze the vehicle information at an event-occurring time relative to an event-occurring timing (S307). For example, the event-occurring time may be one minute before or after the event-occurring timing. The risk-diving-data generator 13 may calculate the event-occurring time between timings of one minute before and one minute after the event-occurring timing so as to extract various pieces of information (e.g. the vehicle information, the position information, and the acceleration information etc.) in the event-occurring time from the driving-state data. The risk-driving-data generator 3 may acquire the ID of the drive recorder 2 included in the event data. Based on the ID of the drive recorder 2, the risk-driving-data generator 13 reads the driver ID, which is recorded in step S305, from the database 104. The risk-diving-data generator 13 obtains an analysis condition which is stored in advance in association with the driver ID and the ID of the drive recorder 2. For example, the analysis condition has been identified by the driver ID or the ID of the drive recorder 2, and therefore it is possible to produce an analysis result according to an enterprise or an individual driver using the drive recorder 2 mounted on a vehicle. In this connection, the driver ID or the ID of the drive recorder 2 may represent one example of the information showing attributes of a driver.

The risk-driving-data generator 13 may analyze the information (hereinafter, referred to as “extracted information”) extracted from the driving-state data in the event-occurring time according to the analysis condition, thus generating risk driving data as an analysis result (S308). The analysis condition may include the information used for analysis, the information representing a range of values designated by the information, and the information representing an analysis method. According to a result of analyzing the extracted information according to the analysis method indicated by the analysis condition, the risk-driving-data generator 13 determines whether or not an event of a vehicle is important information. For example, the analysis condition may be a condition stipulated by the aforementioned operation condition data. When the extracted information includes the acceleration information having an operation flag “1”, the risk-driving-data generator 13 may read the speed information of a vehicle from the extracted information in predetermined intervals of time during the event-occurring time. The risk-driving-data generator 13 may identify a risk-drive type according to the transition of the acceleration information and the speed information during the event-occurring time. Upon identifying the risk-dive type having an operation flag “1”, the risk-driving-data generator 13 generates the risk driving data including the identification of the risk-drive type. The risk drive data may include the acceleration information and the speed information during the event-occurring time as well as the extracted information extracted from other driving-state data. The output part 19 is configured to acquire the risk driving data generated by the risk-driving-data generator 13. The output part 19 may record the risk diving data on a recorder such as the database 104 in association with the driver ID or the ID of the drive recorder 2 (S309).

The risk-driving-data generator 13 may determine whether to upload images according to the risk-drive type (S310). An upload determination condition to determine whether to upload images has been determined according to attributes of a driver such as the driver ID and the ID of the drive recorder 2, and therefore the upload determination condition can be stored in the driving-state monitoring device 1 in advance. Upon identifying the risk-drive type requiring uploading images, the risk-driving-data generator 13 may output to the image acquisition part 14 an image-acquisition request including at least the event-occurring time and the ID of the drive recorder 2. Upon inputting the image-acquisition request from the risk-driving-data generator 13, the image acquisition part 14 may retransmit the image-acquisition request destined to a communication address of the drive recorder 2 associated with the ID of the drive recorder 2 through the communication module 105 (S311).

The control device 24 of the drive recorder 2 receives the image-acquisition request. The upload image transmitter 248 of the control device 24 may identify the upload image data corresponding to the event-occurring time included in the image-acquisition request among the upload image data generated by the upload image generator 245, and then the upload image transmitter 248 may temporarily store the upload image data in a buffer in order to stand by its transmission process. For example, when the driving-state monitoring device 1 restarts its operation upon starting the electrical system of a vehicle again, the upload image transmitter 248 may transmit the upload image data, which was temporarily stored in a buffer in order to stand by its transmission process, to the driving-state monitoring device 1 through the communication device 22. In the driving-state monitoring device 1, the image acquisition part 14 is configured to acquire the upload image data transmitted from the drive recorder 2 (S312). The image acquisition part 14 may record the upload image data in association with the risk driving data (S313).

According to the above process, the driving-state monitoring device 1 is able to store the upload image data and the risk driving data according to attributes of a driver. According to the above process, the upload image data may be moving-image data or still images representing part of moving images captured according to attributes of a driver. Therefore, it is possible to reduce an amount of the upload image data to be transmitted from the drive recorder 2 to the driving-state monitoring device 1. In addition, the drive recorder 2 when restarting its operation may transmit the upload image data to the driving-state monitoring device 1. For this reason, it is possible to transmit a large capacity of upload image data to the driving-state monitoring device 1 in a time zone of stopping a vehicle, i.e. a time zone in which a communication quality is stabilized due to the stoppage of a vehicle.

When the driver ID identification part 15 fails to identify a driver ID having a degree of coincidence of the facial feature information or its average value equal to or above the predetermined threshold in step S303, the driver ID identification part 15 may determine whether or not an authentication process has been carried out a predetermined number of times (S321). When the authentication process has not been carried out a predetermined number of times, the driver ID identification part 15 may repeatedly carry out an authentication process (S303) using the authentication image data included in the next driving-state data. When the authentication process has been carried out a predetermined number of times, the driver ID identification part 15 determines an authentication failure (S322). Upon determining the authentication failure, the driver ID identification part 15 generates a temporal ID (S323). The temporal ID is output to the recording part 16. The recording part 16 records the temporal ID and the driving-state data in the database 104 in association with the ID of the drive recorder 2 (S324). Thereafter, the processing proceeds to step S306.

The driver ID identification part 15 notifies a manager of the temporal ID generated in step S323 at a predetermined timing. For example, the driver ID identification part 15 transmits the screen information, which includes the temporal ID and a recording-destination URL of the driving-state data recorded on the database 104 in association with the temporal ID, to a manager's terminal on its screen. Accordingly, the screen information including the temporal ID and the recording-destination URL of the driving-state data will be displayed on the manager's terminal.

The manager may access the recording-destination URL to read the driving-state data and to thereby display the authentication image data and the upload image data, which are included in the driving-state data, on the terminal. With reference to images displayed on the terminal, the manager may determine whether the feature information of a driver's facial image matches a driver registered in the database 104. When the feature information of a driver's facial image has been recorded in the database 104, the manger may operate the terminal to rewrite the temporal ID, which is recorded in the database 104, with a driver ID of a driver. Alternatively, the manager may input the temporal ID and the driver ID into the driving-state monitoring device 1 such that the driver ID identification part 15 may carry out a process of rewriting the temporal ID recorded in the database 104 with the driver ID of a driver according to a manager's operation.

When the feature information of a driver's facial image is not recorded in the database 104, the manager may identify a driver indicated by the authentication image data and/or the upload image data, thus issuing a new driver ID for the driver. The manager will carry out an operation to rewrite the temporal ID recorded in the database 104 with the newly-issued driver ID. Alternatively, the manager may input the temporal ID and the newly-issued ID to the driving-state monitoring device 1 such that the driver ID identification part 15 may carry out a process of rewriting the temporal ID recorded in the database 104 with the newly-issued driver ID according to a manager's operation.

According to the above process, the driving-state monitoring device 1 is able to identify the driver ID of a driver based on the authentication image data received from the drive recorder 2. Accordingly, it is possible for the driving-state monitoring device 1 to recognize a driver ID of a driver without the necessity of driver's operations to insert a memory card into the drive recorder 2 and to input an identification such as a driver ID into the drive recorder 2 by himself/herself.

In the present embodiment, it is possible to record in the database 104 the driver ID identified according the captured image of a driver, the driving-state data, and the upload image data which are associated with each other. Accordingly, even when an ID of a different person than a driver who may actually drive a vehicle is input to the drive recorder 2, it is possible to prevent an unauthorized behavior to erroneously or disguisedly record an ID of a different person in the database 104 in association with the driving-state data. In addition, the driver ID identification part 15 is configured to issue a temporal ID and to notify a manager of the temporal ID when failing to identify a driver ID according to the authentication image data based on the captured image of a driver, and therefore it is possible to issue an appropriate driver ID by a manager and to thereby record the driver ID in the database 104 in association with the driving-state data. Accordingly, it is possible to precisely manage the driving-state data for each driver obtained from the drive recorder 2 by monitoring the driving state of a driver who may be allowed to drive a plurality of vehicles.

The alarm information generator 18 of the driving-state monitoring device 1 is configured to generate the alarm information including at least the driving-state data and the risk-drive type identified by the risk-driving-data generator 13 (S314). The output part 19 may transmit the alarm information to the communication address of the drive recorder 2, which is identified by the ID of the drive recorder 2 in advance, through the communication module 105 (S315). Thus, the drive recorder 2 may receive the alarm information from the driving-state monitoring device 1. Upon receiving the alarm information, the drive recorder 2 may output the predetermined information in a manner according to the risk-drive type included in the alarm information. For example, the drive recorder 2 may generate sound or voice according to the risk-drive type. Accordingly, the drive recorder 2 is able to produce an alarm for a driver of a vehicle in a manner according to the risk-drive type.

The report generator 17 of the driving-state monitoring device 1 is configured to determine whether to generate the report data at a predetermined timing (S316). According to the determination result, the report generator 17 may generate the report data for a driver at a predetermined timing (S317). For example, the predetermined timing of generating the report data may be a predetermined time such as once a day or twenty-four o'clock. As a concrete example of a method f generating the report data, for example, the report generator 17 may acquire a report-generating condition which is stored in advance based on at least one of a driver ID and an ID of the drive recorder 2. The report-generating condition may include the type of information to be described in a report and a transmission destination of a report. The report generator 17 generates the report data according to the report-generating condition. For example, the report data may include an idling time representing a time elapsed after starting a vehicle, which is included in the vehicle information, a radar chart for each risk-drive type according to a risk-occurring count, a score which the report generator 17 calculates based on the risk-drive type and the risk-occurring count, and a risk ranking which is counted by the report generator 17 based on the score. The output part 19 may acquire the report data generated by the report generator 17 so as to transmit the report data to a transmission-destination address based on the driver ID and the ID of the drive recorder 2 (S318). The control part 11 of the driving-state monitoring device 1 may determine whether to terminate the above process (S319). The driving-state monitoring device 1 may repeatedly execute a series of steps S302 through S318 and a series of steps S321 through S324 until a decision to terminate the process. As described above, the driving-state monitoring device 1 is able to generate the report data according to attributes of driver and to thereby transmit the report data to a desired transmission destination.

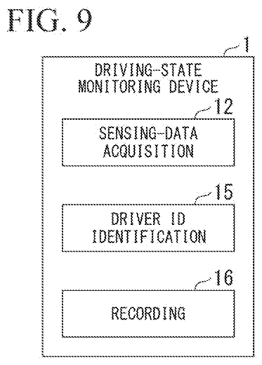

FIG. 9 shows a minimum configuration of the driving-state monitoring device 1. As shown in FIG. 9, the driving-state monitoring device 1 should include at least the sensing-data acquisition part 12, the driver ID identification part 15, and the recording part 16. The sensing-data acquisition part 12 is configured to acquire the driving-state data and the captured images of drivers from a plurality of drive recorders 2 configured to communicate with the driving-state monitoring device 1. The driver ID identification part 15 is configured to carry out an authentication process with respect to a driver of a vehicle. That is, the driver ID identification part 15 is configured to determine whether a driver may match a driver registered in advance based on the information of a driver included in a plurality of images among the captured images of the drive recorder 2. The driver ID identification part 15 is configured to identify a driver ID with respect to a driver successfully authenticated. The recording part 16 is configured to record the driving-state data transmitted from the drive recorder 2 in association with the driver ID which is identified based on the captured image(s) ascribed to the driving-state data.

The driving-state monitoring device 1 and the drive recorder 2 have been described above, but the present invention is not necessarily limited to the foregoing embodiment. In this connection, the driving-state monitoring device 1 and the control device 24 of the drive recorder 2 may include a computer system therein. The aforementioned processes are stored as computer programs on computer-readable storage media, whereby a computer may read and execute computer programs from storage media, thus implementing the aforementioned processes.

Computer programs may achieve part of functions implemented by the driving-state monitoring device 1 and the drive recorder 2. Alternatively, computer programs may be differential programs (or differential files) which can be combined with pre-installed programs to achieve the foregoing functions.

Lastly, the present invention is not necessarily limited to the foregoing embodiment, and therefore the present invention may embrace modifications and design changes within the scope of the invention as defined by the appended claims. In this connection, a driving-state sensing device configured to communicate with the driving-state monitoring device 1 is not necessarily limited to the drive recorder 2. For example, the driving-state sensing device may use an onboard computer or a camera mounted on a vehicle.

### INDUSTRIAL APPLICABILITY

The present invention is directed to the driving-state monitoring device and the driving-state monitoring method which are designed to monitor the driving-state data of a driver of a vehicle and to thereby provide a driver with the alarm information and the report information. Besides, the present invention is applicable to other systems configured to provide various traffic information, which may provide a traffic management system with the information of a driver who may do risk driving.

### REFERENCE SIGNS LIST

1 driving-state monitoring device
2 drive recorder
11 control part
12 sensing-data acquisition part
13 risk-driving-data generator
14 image acquisition part
15 driver ID identification part
16 recording part
17 report generator
18 alarm information generator
19 output part
21 sensor
22 communication device
23 camera
24 control device
25 storage device
211 acceleration sensor
212 sound-detection sensor
213 GPS sensor
241 vehicle-information acquisition part
242 position-information acquisition part
243 acceleration-information acquisition part
244 event detection part
245 image generator
246 driving-state data transmitter
247 event-data transmitter
248 upload-image transmitter
249 authentication-image-data generator

1. An apparatus comprising:
a memory configured to store instructions; and
at least one processor configured to execute the instructions to:
acquire a captured image of a driver of a vehicle;
acquire driving-state data of the vehicle;
automatically determine identification information of the driver from among identification information of drivers registered in advance based on information of the driver included in the captured image;
in a case that the identification information of the driver is not automatically determined, output the captured image of the driver to a terminal device, acquire user input related to the driver to the terminal device, and determine the identification information of the driver from among identification information of drivers registered in advance based on the user input; and
record the driving-state data in association with the identification information of the driver.

2. The apparatus according to claim 1, wherein the at least one processor is configured to execute the instructions to acquire driving-state data including acceleration information of the vehicle, and record the driving-state data including acceleration information of the vehicle in association with the identification information of the driver.

3. The apparatus according to claim 1, wherein the at least one processor is configured to execute the instructions to calculate a degree of coincidence between facial feature information included in the captured image of the driver and facial feature information of drivers registered in advance, and determine the identification information of the driver as identification information of a driver registered in advance associated with facial feature information having the degree of coincidence equal to or above a predetermined threshold.

4. The apparatus according to claim 1, wherein the at least one processor is configured to execute the instructions to, in a case that the user input related to the driver to the terminal device indicates that identification information of the driver is not registered in advance, record the driving-state data in association with new identification information.

5. The apparatus according to claim 1, wherein the at least one processor is configured to execute the instructions to, in a case that the identification information of the driver is not automatically determined, generate temporal identification information for the driver and record the driving-state data in association with the temporal identification information.

6. The apparatus according to claim 4, wherein the at least one processor is configured to execute the instructions to, in a case that the identification information of the driver is determined based on the user input, record the driving-state data in association with the determined identification information in place of the temporal identification information.

7. A system comprising a driving-state sensing device placed on a vehicle and a driving-state monitoring device, wherein the driving-state monitoring device comprises a memory configured to store instructions, and at least one processor configured to execute the instructions to:
acquire a captured image of a driver of the vehicle transmitted from the driving-state sensing device;
acquire driving-state data of the vehicle transmitted from the driving-state sensing device;
automatically determine identification information of the driver from among identification information of drivers registered in advance based on information of the driver included in the captured image;
in a case that the identification information of the driver is not automatically determined, output the captured image of the driver to a terminal device, acquire user input related to the driver to the terminal device, and determine the identification information of the driver from among identification information of drivers registered in advance based on the user input; and
record the driving-state data in association with the identification information of the driver.

8. The system according to claim 7, wherein the at least one processor is configured to execute the instructions to acquire driving-state data including acceleration information of the vehicle transmitted from the driving-state sensing device, and record the driving-state data including acceleration information of the vehicle in association with the identification information of the driver.

9. The system according to claim 7, wherein the at least one processor is configured to execute the instructions to calculate a degree of coincidence between facial feature information included in the captured image of the driver and facial feature information of drivers registered in advance, and determine the identification information of the driver as identification information of a driver registered in advance associated with facial feature information having the degree of coincidence equal to or above a predetermined threshold.

10. The system according to claim 7, wherein the at least one processor is configured to execute the instructions to, in a case that the user input related to the driver to the terminal device indicates that identification information of the driver is not registered in advance, record the driving-state data in association with new identification information.

11. The system according to claim 7, wherein the at least one processor is configured to execute the instructions to, in a case that the identification information of the driver is not automatically determined, generate temporal identification information for the driver and record the driving-state data in association with the temporal identification information.

12. The system according to claim 11, wherein the at least one processor is configured to execute the instructions to, in a case that the identification information of the driver is determined based on the user input, record the driving-state data in association with the determined identification information in place of the temporal identification information.

13. A method adapted to a driving-state monitoring device configured to communicate with a driving-state sensing device placed on a vehicle, the method comprising:
acquiring a captured image of a driver of the vehicle transmitted from the driving-state sensing device;
acquiring driving-state data of the vehicle transmitted from the driving-state sensing device;
automatically determining identification information of the driver from among identification information of drivers registered in advance based on information of the driver included in the captured image;
in a case that the identification information of the driver is not automatically determined, outputting the captured image of the driver to a terminal device, acquiring user input related to the driver to the terminal device, and determining the identification information of the driver from among identification information of drivers registered in advance based on the user input; and
recording the driving-state data in association with the identification information of the driver.

14. The method according to claim 13, the method comprising:
acquiring driving-state data including acceleration information of the vehicle transmitted from the driving-state sensing device; and
recording the driving-state data including acceleration information of the vehicle in association with the identification information of the driver.

15. The method according to claim 13, the method further comprising:
calculating a degree of coincidence between facial feature information included in the captured image of the driver and facial feature information of drivers registered in advance; and
determining the identification information of the driver as identification information of a driver registered in advance associated with facial feature information having the degree of coincidence equal to or above a predetermined threshold.

16. The method according to claim 13, the method further comprising:
in a case that the user input related to the driver to the terminal device indicates that identification information of the driver is not registered in advance, recording the driving-state data in association with new identification information.

17. The method according to claim 13, the method further comprising:
in a case that the identification information of the driver is not automatically determined, generating temporal identification information for the driver and recording the driving-state data in association with the temporal identification information.

18. The method according to claim 17, the method further comprising:
in a case that the identification information of the driver is determined based on the user input, recording the driving-state data in association with the determined identification information in place of the temporal identification information.

19. A non-transitory computer-readable storage medium configured to store a program causing a computer to execute processing of:
acquiring a captured image of a driver of a vehicle;
acquiring driving-state data of the vehicle;
automatically determining identification information of the driver from among identification information of drivers registered in advance based on information of the driver included in the captured image;
in a case that the identification information of the driver is not automatically determined, outputting the captured image of the driver to a terminal device, acquiring user input related to the driver to the terminal device, and determining the identification information of the driver from among identification information of drivers registered in advance based on the user input; and
recording the driving-state data in association with the identification information of the driver.

20. A driving-state sensing device to be placed on a vehicle, the driving-state sensing device comprising:
a memory configured to store instructions; and
at least one processor configured to execute the instructions to:
capture an image of a driver of the vehicle;
acquire driving-state data of the vehicle; and
transmit the driving-state data in association with the captured image of the driver to a driving-state monitoring device,
wherein the captured image of the driver is used to automatically determine identification information of the driver from among identification information of drivers registered in advance,
wherein in a case that the identification information of the driver is not automatically determined, the captured image of the driver is output to a terminal device to acquire user input related to the driver to the terminal device and determine the identification information of the driver from among identification information of drivers registered in advance based on the user input, and
wherein the driving-state data is recorded in association with the identification information of the driver in the driving-state monitoring device.
